(19) United States
(12) Patent Application Publication
(10) Pub. No.: US 2025/0026207 A1
(43) Pub. Date: Jan. 23, 2025

(54) THREE-PHASE TO THREE-PHASE DIRECT MATRIX CONVERTER

(71) Applicants: BorgWarner Inc., Auburn Hills, MI (US); BOARD OF TRUSTEES OF MICHIGAN STATE UNIVERSITY, East Lansing, MI (US)

(72) Inventors: Woongkul Lee, Okemos, MI (US); Brian Wightman, Davisburg, MI (US)

(21) Appl. No.: 18/223,778

(22) Filed: Jul. 19, 2023

(51) Int. Cl. B60L 53/10; H02J 3/32; H02M 3/335; H02M 7/797

(52) U.S. Cl. CPC B60L 53/11; H02J 3/322; H02M 3/33584; H02M 7/797; B60L 55/00; B60L 2210/30

(57) ABSTRACT

A direct current (DC) fast charger for charging batteries of electric vehicles (EVs) including a primary circuit, having nine switches, electrically linked to primary wires of a transformer and configured to receive three-phase alternating current (AC) power and increase the frequency of the AC power; and a secondary circuit, including six switches or diodes arranged to rectify AC voltage into DC power, that is electrically linked to a secondary wire of the transformer.

### GOVERNMENT INTEREST

This invention was made with government support under the DE-EE0009869 contract, awarded by the United States Department of Energy, Energy Efficiency & Renewable Energy EE-1 Office. The U.S. Government has certain rights in the invention.

### TECHNICAL FIELD

The present application relates to electric vehicles (EVs) and, more particularly, to chargers for charging EVs.

### BACKGROUND

Modern vehicles are increasingly propelled at least partially or wholly by electric motors. The vehicles, often referred to as electric vehicles (EVs), include a vehicle battery and one or more electric motors that drive the vehicle wheels. The vehicle batteries are periodically coupled to a battery charger. As motorists purchase increasing quantities of EVs, they will want to be able to charge the vehicle batteries relatively quickly. Therefore, faster and more efficient vehicle battery chargers are helpful.

### SUMMARY

In one implementation, a direct current (DC) fast charger for charging batteries of electric vehicles (EVs) including a primary circuit, having nine switches, electrically linked to primary wires of a transformer and configured to receive three-phase alternating current (AC) power and increase the frequency of the AC power; and a secondary circuit, including six switches or diodes arranged to rectify AC power into DC power, that is electrically linked to a secondary wire of the transformer.

In another implementation, a DC fast charger for charging batteries of EVs, includes a primary circuit electrically linked to a primary wire of a transformer, configured to receive three-phase alternating current (AC) power and increase the frequency of the AC power; and a secondary circuit, including six switches or diodes electrically linked to a secondary wire of the transformer, that receives the AC power and rectifies the increased frequency AC power into DC power.

### BRIEF DESCRIPTION OF THE DRAWINGS

FIG. 1 is a block diagram depicting an implementation of an electric vehicle;

FIG. 2 is a circuit diagram depicting an implementation of a DC fast charger AC/DC power converter;

FIG. 3 is a circuit diagram depicting another implementation of a DC fast charger AC/DC power converter; and

FIG. 4 is a circuit diagram depicting yet another implementation of a DC fast charger AC/DC power converter.

### DETAILED DESCRIPTION

A three-phase to three-phase direct matrix converter can be used in an electric vehicle (EV) battery charger that supplies direct current (DC) electrical power to the EV. In the past, a six-switch indirect matrix converter using six bidirectional switches in a primary circuit and four switches in a secondary circuit has received three-phase alternating current (AC) electrical power from an electrical grid to single-phase AC electrical power. The single-phase AC power could then be converted to DC electrical power. However, it is possible to implement an EV battery charger that receives the three-phase AC electrical power from the grid and increases the amount of electrical power output from the EV battery charger three-fold while also decreasing the number of switching devices used to do so.

The present EV battery charger, also referred to as a DC fast charger, can include a three-phase to three-phase direct matrix converter. The direct matrix converter transforms low frequency three-phase AC power to high-frequency three-phase AC power at a primary circuit using nine bidirectional switches. The high-frequency three-phase AC power can then be converted to DC electrical power at the secondary circuit using six switches. The switches in the primary circuit and secondary circuits can be connected in a variety of configurations, depending on the application. For example, the switches in the primary circuit and the secondary circuit can arranged as a Wye-Wye transformer in one implementation. Or in another implementation, the switches can be arranged as a Delta-Delta transformer. Yet another implementation is a Wye-Delta transformer.

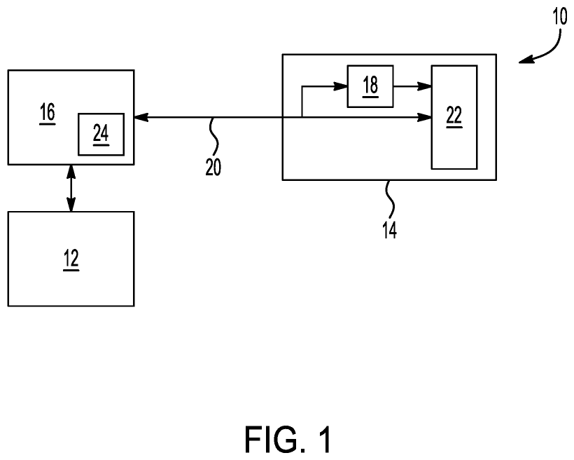

Turning to FIG. 1, an implementation of an electrical system 10 is shown including an electrical grid 12 and an electric vehicle (EV) 14 that can either receive electrical power from or provide electrical power to the grid 12. The electrical grid 12 can include any one of a number of electrical power generators and electrical delivery mechanisms. Electrical generators (not shown) create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated relatively long distances. Once the electrical power reaches a location where it is intended to be used, electrical transformers (not shown) can be used to reduce the voltage level before ultimately being provided to a residence or business. In one implementation, the voltage level of AC electrical power used is 360-510 volts RMS AC three-phase at a frequency of 50-60 hz. However, this voltage can be a different value.

An EV charging station, referred to here as a DC fast charger 16, can receive AC electrical voltage from the grid 12, convert the AC electrical voltage into a higher-frequency AC electrical voltage, convert the higher-frequency AC electrical voltage into DC voltage, and provide the DC electrical voltage to the EV 14. Also, the DC fast charger 16 can receive stored electrical power in the form of DC electrical voltage from an EV battery 22, convert the received DC electrical voltage to AC electrical voltage and transfer it to the grid 12. The DC fast charger 16 can be geographically fixed, such as a charging station located in a vehicle garage or in a vehicle parking lot. The DC fast charger 16 can include an input terminal that receives the AC electrical power from the grid 12 and communicates converted DC electrical power to the EV battery 22 directly, bypassing an on-board vehicle battery charger 18 included on the EV 14. An electrical cable 20 can detachably connect with an electrical receptacle on the EV 14 and electrically link the DC fast charger 16 with the EV 14 so that DC electrical voltage can be communicated between the DC fast charger 16 and the EV battery 22. The DC fast charger 16 can receive AC power from the grid 12 and have a power rating of 180-1100 kW provided to the EV 14. This type of DC fast charging may be referred to as Level 3 megawatt EV charging. However, the EV charging station can be using different standards. The term “electric vehicle” or “EV” can refer to vehicles that are propelled, either wholly or partially, by electric motors. EV can refer to electric vehicles, plug-in electric vehicles, hybrid-electric vehicles, and battery-powered vehicles. The EV battery 22 can supply DC electrical power controlled by power electronics to the electric motors that propel the EV. The EV battery 22 or batteries are rechargeable and can include lead-acid batteries, nickel cadmium (NiCd), nickel metal hydride, lithium-ion, and lithium polymer batteries. A typical range of vehicle battery voltages can range from 100 to 1000V of DC electrical power (VDC).

The on-board vehicle battery charger 18 can include a power factor correction (PFC) module having a switching circuit that converts AC electrical power into DC electrical power. In addition, the switching circuit 26 can also act as an inverter that converts high frequency AC electrical power received from the DC electrical power through a secondary circuit 28 and transformer into AC electrical power, which can be transmitted outside of the EV 14. A microprocessor (not shown) electrically linked to the gate of each switch can control the rectification of incoming AC electrical power as well as the inversion of outgoing DC electrical power. A control system, implemented as computer-readable instructions executable by the microprocessor, can be stored in non-volatile memory and called on to control functionality of the DC fast charger 16. This will be discussed in more detail below.

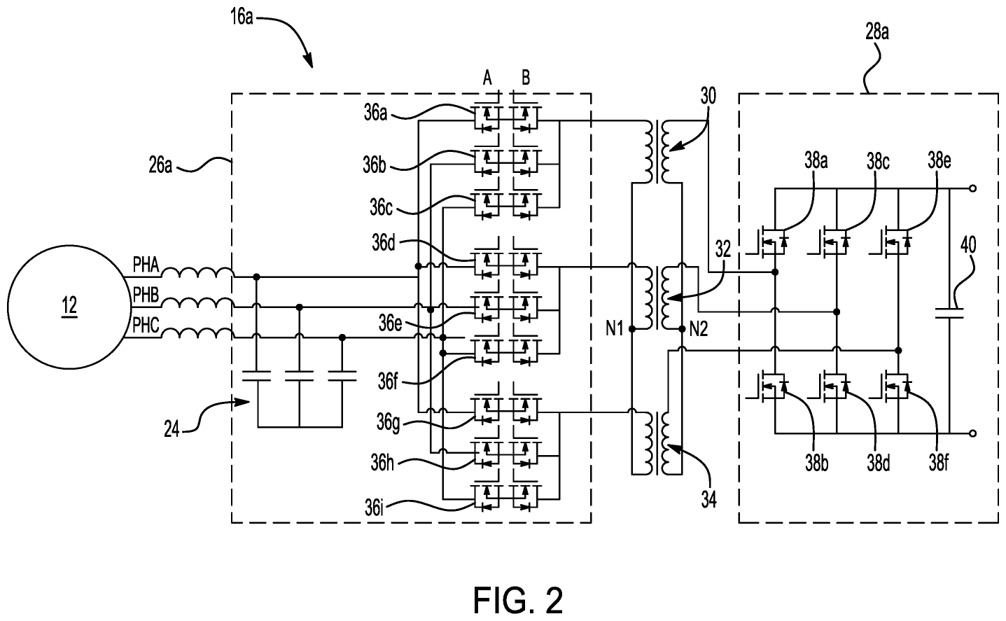

FIG. 2 depicts an implementation of the DC fast charger 16a. The DC fast charger 16a is a direct matrix converter that includes a primary circuit 26a and a secondary circuit 28a inductively coupled together via a plurality of transformers 30, 32, 34. The primary circuit 26a includes nine switches 36 electrically coupled to the grid 12. A first phase (PHA) includes three switches 36a-c, a second phase (PHB) includes three switches 36d-f, and a third phase (PHC) includes three switches 36g-i. The switches 36 can be implemented using bipolar junction transistors or field effect transistors (FETs), such as insulated gate bipolar transistors (IGBTs), metal-oxide-semiconductor field effect transistors (MOSFETs), or gallium nitride transistors (GaN). The switches 36 can be bidirectional or reverse-blocking such that they are four-quadrant switches capable of conducting positive or negative on-state current and blocking positive or negative off-state voltage. A number of different circuit configurations can be used to implement such a switch any of which could be implemented in the DC fast charger described herein. In one implementation, each switch 36 includes an A side MOSFET and a B side MOSFET with gates that can be electrically connected to a microprocessor.

The nine switches 36a-i can be electrically coupled to three legs of the electrical grid PHA, PHB, PHC. Bulk capacitance 24 can be electrically connected to the legs PHA, PHB, PHC of the grid 12. Each phase and three switches electrically coupled to each phase can also be coupled to a transformer. The primary circuit 26a and the secondary circuit 28a are shown in a Wye-Wye configuration. For example, the first phase (PHA) can be coupled to switches 36a, 36d, and 36f. The second phase (PHB) can be coupled to switches 36b, 36e, and 36h. The third phase (PHC) can be coupled to switches 36c, 36f, and 36i. Switches 36a-c can also be electrically connected to a primary wire of the first transformer 30. Switches 36d-f can also be electrically connected to a primary wire of the second transformer 32. Switches 36g-i can also be electrically connected to a primary wire of the third transformer 34. The primary wires of the transformers 30, 32, 34 can be electrically connected together such that a common neutral node (N1) exists within the primary circuit 26a.

The secondary circuit 28a is electrically connected to secondary windings of the transformers 30, 32, 34. The secondary circuit 28a includes six switches 38a-f. The switches 38 can be implemented using bipolar junction transistor or field effect transistors (FETs), such as insulated gate bipolar transistors (IGBTs) metal-oxide-semiconductor field effect transistors (MOSFETs). The secondary circuit 28a can include a capacitor 40 that smooths the output DC voltage. The EV battery 22 can be electrically connected to the switches 38 such that the secondary circuit 28a rectifies the AC voltage induced through the secondary windings of the transformers 30, 32, 34 into DC voltage applied to the EV battery 22. The secondary circuit 28a can be implemented such that the secondary wires of the transformers 30, 32, 34 are electrically connected to have a common neutral node (N2).

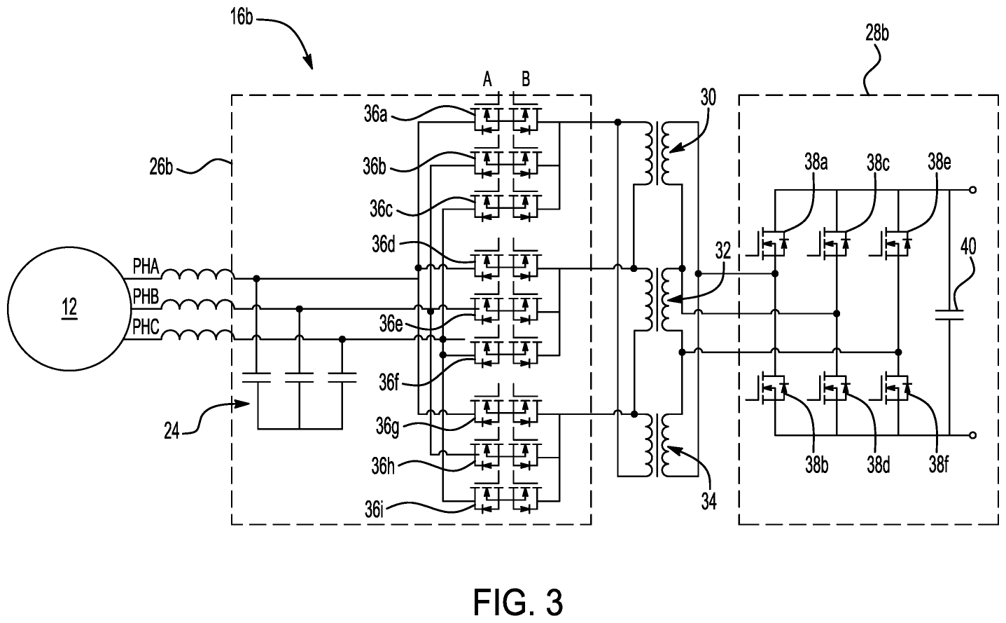

Turning to FIG. 3, another implementation of a DC fast charger 16b is shown. The DC fast charger 16b is a direct matrix converter that includes a primary circuit 26b and a secondary circuit 28b inductively coupled together via a plurality of transformers 30, 32, 34. The primary circuit 26b includes nine switches 36 electrically coupled to the grid 12. The primary circuit 26b and the secondary circuit 28b are arranged in a Delta-Delta configuration. The first phase (PHA) can be coupled to switches 36a, 36d, and 36f. The second phase (PHB) can be coupled to switches 36b, 36e, and 36h. The third phase (PHC) can be coupled to switches 36c, 36f, and 36i. Switches 36a-c can also be electrically connected to a primary wire of the first transformer 30. Switches 36d-f can also be electrically connected to a primary wire of the second transformer 32. Switches 36g-i can also be electrically connected to a primary wire of the third transformer 34. The primary wires of the transformers 30, 32, 34 can be electrically connected together in series. The secondary circuit 28b can be implemented such that the secondary wires of the transformers can be wired to the switches 38 in series. In other implementations, the switches 38 in the secondary circuit 28b can be replaced with passive electrical components, such as diodes.

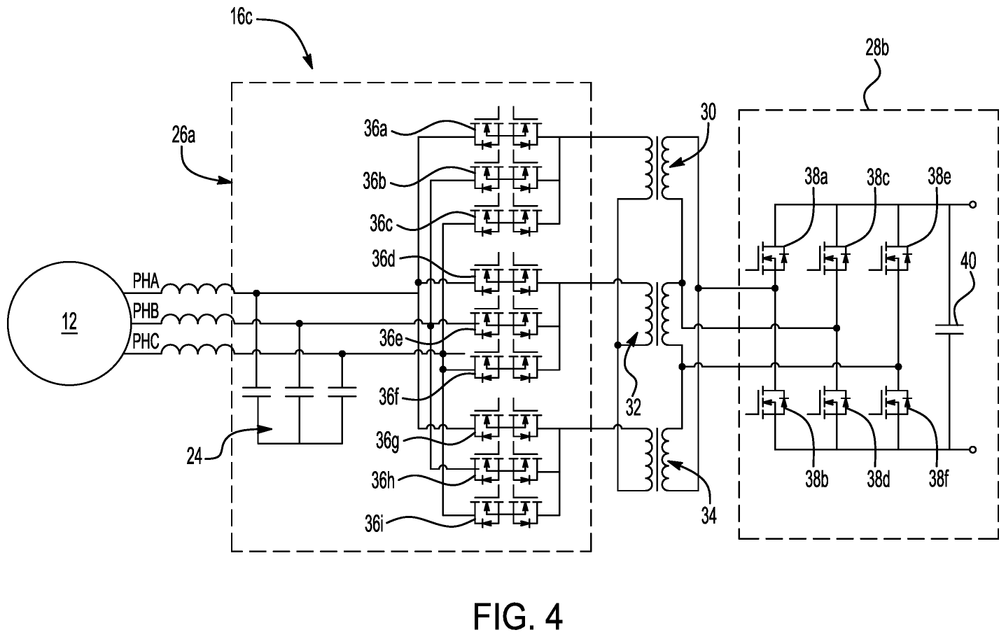

FIG. 4 depicts another implementation of a DC fast charger 16c. The DC fast charger 16c includes a primary circuit 26a and a secondary circuit 28b arranged in a Wye-Delta configuration. The DC fast charger includes the primary circuit 26a and the secondary circuit 26b described above inductively linked via a plurality of transformers 30, 32, 34.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A direct current (DC) fast charger for charging batteries of electric vehicles (EVs), comprising:
a primary circuit in the form of a three-phase to three-phase direct matrix converter, including nine switches, electrically linked to primary wires of a transformer, each of the nine switches includes an A-side switch and a B-side switch wired in series having opposing body diodes in a reverse-blocking arrangement and configured to receive three-phase alternating current (AC) power from an electrical grid and increase the frequency of the AC power.

2. The DC fast charger recited in claim 1, further comprising a control system, electrically linked to the nine switches.

3. The DC fast charger recited in claim 1, wherein the DC fast charger includes a plurality of transformers.

4. The DC fast charger recited in claim 1, wherein the DC fast charger includes a single three-phase transformer.

5. The DC fast charger recited in claim 1, wherein the nine switches in the primary circuit are bi-directional.

6. (canceled)

7. The DC fast charger recited in claim 1, wherein the primary circuit and the secondary circuit are configured in a Wye-Wye orientation.

8. The DC fast charger recited in claim 1, wherein the primary circuit and the secondary circuit are configured in a Delta-Delta configuration.

9. The DC fast charger recited in claim 1, wherein the primary circuit and the secondary circuit are configured in a Delta-Wye configuration.

10. A direct current (DC) fast charger for charging batteries of electric vehicles (EVs), comprising:
a primary circuit in the form of a three-phase to three-phase direct matrix converter, electrically linked to primary wires of a transformer, configured to receive three-phase alternating current (AC) power and increase the frequency of the AC power, the primary circuit including an A-side switch and a B-side switch wired in series having opposing body diodes in a reverse-blocking arrangement to each leg of an AC power grid.

11. The DC fast charger recited in claim 10, further comprising a control system, electrically linked to the primary circuit.

12. The DC fast charger recited in claim 10, wherein the fast charger includes a plurality of transformers.

13. The DC fast charger recited in claim 10, wherein the primary circuit includes a plurality of bi-directional switches.

14. The DC fast charger recited in claim 10, wherein the switches in the secondary circuit are bi-directional.

15. The DC fast charger recited in claim 10, wherein the primary circuit and the secondary circuit are configured in a Wye-Wye orientation.

16. The DC fast charger recited in claim 10, wherein the primary circuit and the secondary circuit are configured in a Delta-Delta configuration.

17. The DC fast charger recited in claim 10, wherein the primary circuit and the secondary circuit are configured in a Delta-Wye configuration.

18. The DC fast charger recited in claim 1, further comprising a secondary circuit, including six switches or diodes arranged to rectify AC power into DC power, that is electrically linked to a secondary wire of the transformer.

19. The DC fast charger recited in claim 10, further comprising a secondary circuit, including six switches or diodes electrically linked to a secondary wire of the transformer, that receives the increased frequency three-phase AC power and rectifies the AC power into DC power
